(19) United States
(12) Patent Application Publication
(10) Pub. No.: US 2023/0103220 A1
(43) Pub. Date: Mar. 30, 2023

(54) CHANNEL STATE INFORMATION FEEDBACK BASED ON FULL CHANNEL ESTIMATION

(71) Applicant: QUALCOMM Incorporated, San Diego, CA (US)

(72) Inventors: Hamed Pezeshki, San Diego, CA (US); Tao Luo, San Diego, CA (US); Taesang Yoo, San Diego, CA (US)

(21) Appl. No.: 17/484,209

(22) Filed: Sep. 24, 2021

(51) Int. Cl. H04B 7/06; H04L 5/00; G06N 20/00

(52) U.S. Cl. CPC H04B 7/0658; H04B 7/0617; H04B 7/0639; H04L 5/0051; G06N 20/00

(57) ABSTRACT

Methods, systems, and devices for channel state information feedback based on full channel estimation are described. The method may include receiving a set of beamformed reference signals from a transmit device via a set of receive beams of the receive device, each beamformed reference signal of the set of beamformed reference signals associated with a corresponding transmit beam of a set of transmit beams of the transmit device, determining, based on the set of beamformed reference signals, a channel matrix representative of a communications channel between the receive device and the transmit device, and transmitting, to the transmit device, channel state information based on the channel matrix.

### FIELD OF TECHNOLOGY

The following relates to CHANNEL STATE INFORMATION FEEDBACK BASED ON FULL CHANNEL ESTIMATION, including channel state information feedback based on full channel estimation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless systems may support channel state information feedback based on full channel estimation. In some cases, it may be desirable to improve signal quality, throughput, and reliability for communications between the base station and the UE based on channel state information feedback.

### SUMMARY

The described techniques relate to improved methods, systems, devices, and apparatuses that support channel state information feedback based on full channel estimation. A receive device (e.g., a UE) may receive a set of beamformed reference signals from a transmit device (e.g., a base station). The receive device may receive the set of beamformed reference signals via a set of receive beams of the receive device and perform one or more measurements on the set of beamformed reference signals. In some cases, each beamformed reference signal of the set of beamformed reference signals may be associated with a corresponding transmit beam of a set of transmit beams of the transmit device.

Based on the set of beamformed reference signals and associated measurements, the receive device may determine a channel matrix representative of the full communications channel between the receive device and the transmit device. The full communications channel may alternatively be referred to as the raw communications channel and may reflect transmission properties of the channel independent of any beamforming (e.g., properties that are not specific to the use of any particular transmit beam, receive beam, or combination thereof). Hence, channel state information based on the full communications channel (e.g., based on the corresponding channel matrix) may not be specific to any particular transmit beam, receive beam, or combination thereof and hence may be applicable to any signaling between the transmit device and the receive device, at least within a frequency range (e.g., subband) in which the set of beamformed reference signals are received. For example, where the set of receive beams of the receive device and the set of transmit beams of the transmit device correspond to a codebook, channel state information based on the full communications channel may be used to generate a transmit beam, a receive beam, or both that are not included in the codebook (e.g. does not correspond to a precoder associated with the codebook), which may support further optimized communications between the transmit device and receive device (e.g., communications with higher throughput, higher reliability, or both, among other possibilities).

A method for wireless communication at a receive device is described. The method may include receiving a set of beamformed reference signals from a transmit device via a set of receive beams of the receive device, each beamformed reference signal of the set of beamformed reference signals associated with a corresponding transmit beam of a set of transmit beams of the transmit device, determining, based on the set of beamformed reference signals, a channel matrix representative of a communications channel between the receive device and the transmit device, and transmitting, to the transmit device, channel state information based on the channel matrix.

An apparatus for wireless communication at a receive device is described. The apparatus may include a processor, memory coupled with the processor, and instructions stored in the memory. The instructions may be executable by the processor to cause the apparatus to receive a set of beamformed reference signals from a transmit device via a set of receive beams of the receive device, each beamformed reference signal of the set of beamformed reference signals associated with a corresponding transmit beam of a set of transmit beams of the transmit device, determine, based on the set of beamformed reference signals, a channel matrix representative of a communications channel between the receive device and the transmit device, and transmit, to the transmit device, channel state information based on the channel matrix.

Another apparatus for wireless communication at a receive device is described. The apparatus may include means for receiving a set of beamformed reference signals from a transmit device via a set of receive beams of the receive device, each beamformed reference signal of the set of beamformed reference signals associated with a corresponding transmit beam of a set of transmit beams of the transmit device, means for determining, based on the set of beamformed reference signals, a channel matrix representative of a communications channel between the receive device and the transmit device, and means for transmitting, to the transmit device, channel state information based on the channel matrix.

A non-transitory computer-readable medium storing code for wireless communication at a receive device is described. The code may include instructions executable by a processor to receive a set of beamformed reference signals from a transmit device via a set of receive beams of the receive device, each beamformed reference signal of the set of beamformed reference signals associated with a corresponding transmit beam of a set of transmit beams of the transmit device, determine, based on the set of beamformed reference signals, a channel matrix representative of a communications channel between the receive device and the transmit device, and transmit, to the transmit device, channel state information based on the channel matrix.

In some examples of the method, apparatuses, and non-transitory computer-readable medium described herein, transmitting the channel state information may include operations, features, means, or instructions for transmitting a compressed representation of the channel matrix.

Some examples of the method, apparatuses, and non-transitory computer-readable medium described herein may further include operations, features, means, or instructions for using machine learning or a neural network, or both, to obtain the compressed representation of the channel matrix.

In some examples of the method, apparatuses, and non-transitory computer-readable medium described herein, transmitting the channel state information may include operations, features, means, or instructions for transmitting a precoding matrix indicator that may be independent of the set of receive beams, a rank indicator that may be independent of the set of receive beams, or a channel quality indicator that may be independent of the set of receive beams, or any combination thereof.

In some examples of the method, apparatuses, and non-transitory computer-readable medium described herein, the channel matrix and the channel state information may be specific to a first subband and the method, apparatuses, and non-transitory computer-readable medium may include further operations, features, means, or instructions for receiving a second set of beamformed reference signals from the transmit device via the set of receive beams, the second set of beamformed reference signals within a second subband, determining, based on the second set of beamformed reference signals, a second channel matrix that may be specific to the second subband and representative of a second communications channel between the receive device and the transmit device within the second subband, and transmitting, to the transmit device, second channel state information based on the second channel matrix.

In some examples of the method, apparatuses, and non-transitory computer-readable medium described herein, a size of at least one dimension of the channel matrix may be based on a total quantity of receive antenna ports of the receive device, or a total quantity of transmit antenna ports of the transmit device, or both.

In some examples of the method, apparatuses, and non-transitory computer-readable medium described herein, a size of a first dimension of the channel matrix may be equal to the total quantity of receive antenna ports of the receive device and a size of a second dimension of the channel matrix may be equal to the total quantity of transmit antenna ports of the transmit device.

In some examples of the method, apparatuses, and non-transitory computer-readable medium described herein, the channel state information may be independent of each receive beam of the set of receive beams and each transmit beam of the set of transmit beams.

Some examples of the method, apparatuses, and non-transitory computer-readable medium described herein may further include operations, features, means, or instructions for transmitting, to the transmit device, a capability message indicating that the receive device may be capable of determining the channel matrix representative of the communications channel.

Some examples of the method, apparatuses, and non-transitory computer-readable medium described herein may further include operations, features, means, or instructions for transmitting the channel state information based on the channel matrix may be based on a power level of the receive device, a signal quality associated with the receive device, or a power level of a signal associated with the receive device, or any combination thereof.

Some examples of the method, apparatuses, and non-transitory computer-readable medium described herein may further include operations, features, means, or instructions for receiving, from the transmit device, configuration information indicating resources for receiving the set of beamformed reference signals to determine the channel matrix, resources for transmitting the channel state information based on the channel matrix, or one or more contents of the channel state information based on the channel matrix, or any combination thereof.

Some examples of the method, apparatuses, and non-transitory computer-readable medium described herein may further include operations, features, means, or instructions for communicating with the transmit device, after transmitting the channel state information, using a receive beam that may be independent of a codebook associated with the set of receive beams and generated based on the channel matrix.

A method for wireless communication at a transmit device is described. The method may include transmitting a set of beamformed reference signals to a receive device via a set of transmit beams of the transmit device, each beamformed reference signal of the set of beamformed reference signals associated with a corresponding receive beam of a set of receive beams of the receive device and receiving channel state information from the receive device based on a channel matrix, where the channel matrix is based on the set of beamformed reference signals and is representative of a communications channel between the receive device and the transmit device.

An apparatus for wireless communication at a transmit device is described. The apparatus may include a processor, memory coupled with the processor, and instructions stored in the memory. The instructions may be executable by the processor to cause the apparatus to transmit a set of beamformed reference signals to a receive device via a set of transmit beams of the transmit device, each beamformed reference signal of the set of beamformed reference signals associated with a corresponding receive beam of a set of receive beams of the receive device and receive channel state information from the receive device based on a channel matrix, where the channel matrix is based on the set of beamformed reference signals and is representative of a communications channel between the receive device and the transmit device.

Another apparatus for wireless communication at a transmit device is described. The apparatus may include means for transmitting a set of beamformed reference signals to a receive device via a set of transmit beams of the transmit device, each beamformed reference signal of the set of beamformed reference signals associated with a corresponding receive beam of a set of receive beams of the receive device and means for receiving channel state information from the receive device based on a channel matrix, where the channel matrix is based on the set of beamformed reference signals and is representative of a communications channel between the receive device and the transmit device.

A non-transitory computer-readable medium storing code for wireless communication at a transmit device is described. The code may include instructions executable by a processor to transmit a set of beamformed reference signals to a receive device via a set of transmit beams of the transmit device, each beamformed reference signal of the set of beamformed reference signals associated with a corresponding receive beam of a set of receive beams of the receive device and receive channel state information from the receive device based on a channel matrix, where the channel matrix is based on the set of beamformed reference signals and is representative of a communications channel between the receive device and the transmit device.

In some examples of the method, apparatuses, and non-transitory computer-readable medium described herein, receiving the channel state information may include operations, features, means, or instructions for receiving a compressed representation of the channel matrix and decompressing the compressed representation of the channel matrix.

Some examples of the method, apparatuses, and non-transitory computer-readable medium described herein may further include operations, features, means, or instructions for decompressing the compressed representation of the channel matrix may be based on machine learning or a neural network, or both.

In some examples of the method, apparatuses, and non-transitory computer-readable medium described herein, receiving the channel state information may include operations, features, means, or instructions for receiving a precoding matrix indicator that may be independent of the set of receive beams, a rank indicator that may be independent of the set of receive beams, or a channel quality indicator that may be independent of the set of receive beams, or any combination thereof.

In some examples of the method, apparatuses, and non-transitory computer-readable medium described herein, the channel matrix and the channel state information may be specific to a first subband and the method, apparatuses, and non-transitory computer-readable medium may include further operations, features, means, or instructions for transmitting a second set of beamformed reference signals to the receive device via the set of receive beams, the second set of beamformed reference signals within a second subband and receiving, from the receive device, second channel state information that may be specific to the second subband and may be based on a second channel matrix specific to the second subband, where the second channel matrix may be based on the second set of beamformed reference signals and may be representative of a second communications channel between the receive device and the transmit device within the second subband.

In some examples of the method, apparatuses, and non-transitory computer-readable medium described herein, a size of at least one dimension of the channel matrix may be based on a total quantity of receive antenna ports of the receive device, or a total quantity of transmit antenna ports of the transmit device, or both.

In some examples of the method, apparatuses, and non-transitory computer-readable medium described herein, a size of a first dimension of the channel matrix may be equal to the total quantity of receive antenna ports of the receive device and a size of a second dimension of the channel matrix may be equal to the total quantity of transmit antenna ports of the transmit device.

In some examples of the method, apparatuses, and non-transitory computer-readable medium described herein, the channel state information may be independent of each receive beam of the set of receive beams and each transmit beam of the set of transmit beams.

Some examples of the method, apparatuses, and non-transitory computer-readable medium described herein may further include operations, features, means, or instructions for receiving, from the receive device, a capability message indicating that the receive device may be capable of determining the channel matrix representative of the communications channel.

Some examples of the method, apparatuses, and non-transitory computer-readable medium described herein may further include operations, features, means, or instructions for configuring the receive device to provide the channel state information based on the channel matrix based on a power level of the receive device, a signal quality associated with the receive device, or a power level of a signal associated with the receive device, or any combination thereof.

Some examples of the method, apparatuses, and non-transitory computer-readable medium described herein may further include operations, features, means, or instructions for transmitting, to the receive device, configuration information indicating resources for receiving the set of beamformed reference signals to determine the channel matrix, resources for transmitting the channel state information based on the channel matrix, or one or more contents of the channel state information based on the channel matrix, or any combination thereof.

Some examples of the method, apparatuses, and non-transitory computer-readable medium described herein may further include operations, features, means, or instructions for communicating with the receive device, after receiving the channel state information, using a transmit beam that may be independent of a codebook associated with the set of transmit beams and generated based on the channel matrix.

### BRIEF DESCRIPTION OF THE DRAWINGS

FIG. 1 illustrates an example of a wireless communications system that supports channel state information feedback based on full channel estimation in accordance with aspects of the present disclosure.

FIG. 2 shows a block diagram of a wireless communications system that supports channel state information feedback based on full channel estimation in accordance with aspects of the present disclosure.

FIG. 3 shows a block diagram of a wireless communications system that supports channel state information feedback based on full channel estimation in accordance with aspects of the present disclosure.

FIG. 4 shows a block diagram of an autoencoder that supports channel state information feedback based on full channel estimation in accordance with aspects of the present disclosure.

FIG. 5 shows a block diagram of a process flow that supports channel state information feedback based on full channel estimation in accordance with aspects of the present disclosure.

FIGS. 6 and 7 show block diagrams of devices that support channel state information feedback based on full channel estimation in accordance with aspects of the present disclosure.

FIG. 8 shows a block diagram of a communications manager that supports channel state information feedback based on full channel estimation in accordance with aspects of the present disclosure.

FIG. 9 shows a diagram of a system including a device that supports channel state information feedback based on full channel estimation in accordance with aspects of the present disclosure.

FIGS. 10 and 11 show block diagrams of devices that support channel state information feedback based on full channel estimation in accordance with aspects of the present disclosure.

FIG. 12 shows a block diagram of a communications manager that supports channel state information feedback based on full channel estimation in accordance with aspects of the present disclosure.

FIG. 13 shows a diagram of a system including a device that supports channel state information feedback based on full channel estimation in accordance with aspects of the present disclosure.

FIGS. 14 and 15 show flowcharts illustrating methods that support channel state information feedback based on full channel estimation in accordance with aspects of the present disclosure.

### DETAILED DESCRIPTION

The described techniques support the use of channel state information feedback based on full channel estimation. In some cases, a precoder (e.g., beam measurement configuration) at a transmit device (e.g., base station) or receive device (e.g., UE) may be based on a predefined codebook, where the codebook supports the use of a finite quantity of predefined transmit and receive beams (e.g., transmit and receive beam pairs). In some cases, the predefined codebook (and hence the set of predefined transmit and receive beams) may not be customized for a particular channel or a particular channel environment. Thus, in some cases, even selection of the best transmit beam and receive beam combination (e.g., highest signal quality, etc.) from among the set of predefined transmit and receive beams (e.g., best beam pair link corresponding to the predefined codebook) may result in suboptimal signal quality, throughput, reliability, or a combination thereof, for communications between the transmit device and the receive device.

In some cases, a wireless communications system may support millimeter wave (mmW) communications between UEs and base stations. In some cases, mmW communications may operate in frequency range 2 (FR2) frequency ranges (e.g., 24 GHz to 53 GHz). In some cases, mmW communications may be associated with relatively high attenuation. Accordingly, beamformed communications and related aspects of the teachings herein may be suitable for (but not limited to) mmW communications.

The present techniques provide for a receive device estimating the channel matrix corresponding to a raw channel between a transmit device and the receive device. The estimating may be based on a set of beamformed reference signals that the receive device receives from the transmit device. The receive device may transmit feedback (e.g., channel state information) to the transmit device corresponding to the raw channel. In some cases, the raw channel may refer to a communications channel between the transmit device and the receive device in the absence of beamforming (e.g., as observed at the antenna ports of the transmit device or receive device in the absence of analog beamforming). In some cases, the raw channel may be referred to as the full channel, non-beamformed channel, or complete channel. The raw channel (and related channel state information) may be independent of any beamforming (e.g., not specific to any particular receive beam, transmit beam, or beam pair link) and hence may be applicable to any signaling between the transmit device and the receive device, including beamformed signaling using any beam pair link. For example, the raw channel and related channel state information may be equally applicable regardless of whether the beam pair link includes a predefined transmit beam and predefined receive beams based on the codebook, or whether the beam pair link includes one or more customized beams (e.g., non-codebook-based beams).

In some examples, the receive device may receive a set of beamformed reference signals from the transmit device and, based on the set of beamformed reference signals, may compute a channel matrix corresponding to (e.g., representative of) the raw channel. A size of at least one dimension of the channel matrix may be based on a total quantity of receive antenna ports of the receive device, or a total quantity of transmit antenna ports of the transmit device, or both. For example, a size of a first dimension of the channel matrix may be equal to the total quantity of receive antenna ports of the receive device, and a size of a second dimension of the channel matrix may be equal to the total quantity of transmit antenna ports of the transmit device—e.g., if the receive device has 8 receive antenna ports and the transmit device has 64 transmit antenna ports, the channel matrix may be an 8×64 matrix (e.g., have a first dimension of size 8 and a second dimension of size 64) and thus include 512 elements.

The receive device may transmit feedback regarding the raw channel (e.g., based on the channel matrix) to the transmit device. For example, in some cases, the receive device may compress the channel matrix (e.g., using machine learning or neural network techniques), and the feedback may include the compressed version of the channel matrix. Additionally or alternatively, the feedback may include a precoding matrix indicator (PMI), a rank indicator (RI), or a channel quality indicator (CQI) applicable to the raw channel (e.g., based on the underlying channel matrix), or any combination thereof.

The transmit device may receive the feedback (e.g., decompress the compressed version of the channel matrix) and calibrate a precoder of the transmit device (e.g., design or modify phase shifter coefficients) based on the information provided by the feedback. As such, the transmit device and the receive device may communicate based on the channel state information for the raw channel. In some cases, the transmit and receive beams used for raw channel estimation may correspond to one or more codebooks, but based on the corresponding channel state information, the transmit device and the receive device may subsequently communicate using a beam pair link that includes a custom transmit beam outside the codebook (e.g., having a direction that is in between two or more of the predefined transmit beams corresponding to the codebook), a custom receive beam outside the codebook (e.g., having a direction that is in between two or more of the predefined receive beams corresponding to the codebook), or both. Such improved channel state information feedback, possibly along with the use of customized transmit or receive beams, may support further optimized communications between the transmit device and receive device (e.g., communications with higher throughput, higher reliability, or both, among other possibilities). For example, the present techniques may provide for increasing spectral efficiency of a wireless communications system based on more optimally configuring transmit and receive beams according to the determined channel conditions of the wireless communications system. Additionally or alternatively, the present techniques may provide for customized beamforming in addition to pre-defined codebooks such as discrete Fourier transform (DFT) codebooks.

Aspects of the disclosure are initially described in the context of wireless communications systems. Aspects of the disclosure are further illustrated by and described with reference to system diagrams, autoencoders, and process flows that relate to channel state information feedback based on full channel estimation. Aspects of the disclosure are further illustrated by and described with reference to apparatus diagrams, system diagrams, and flowcharts that relate to channel state information feedback based on full channel estimation. Though certain examples may be described herein in which the receive device is a UE and the transmit device is a base station, it is to be understood that the receive device and transmit device may both be any type of wireless device.

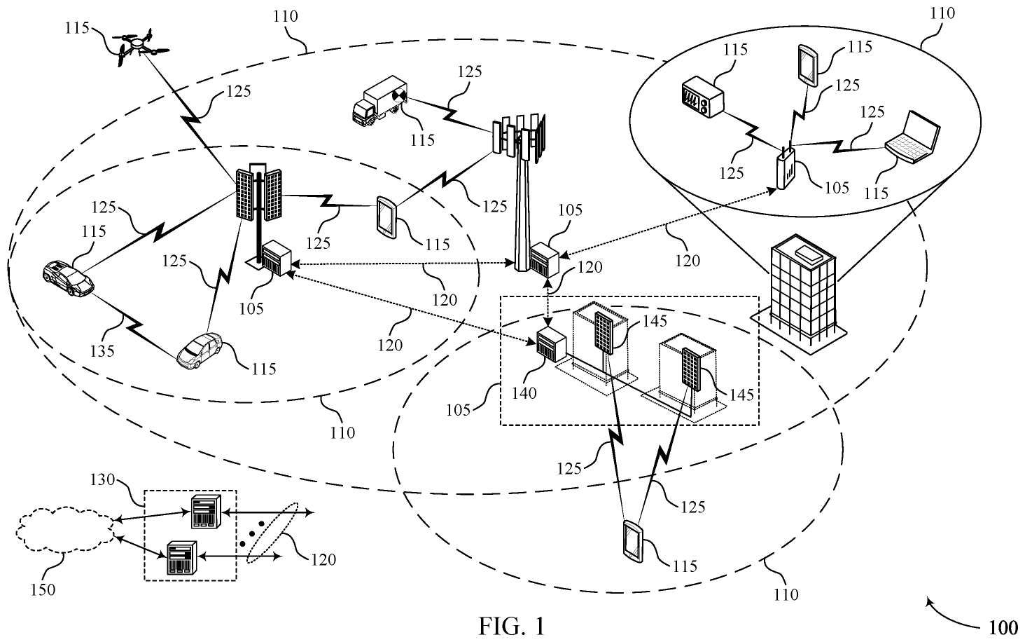

FIG. 1 illustrates an example of a wireless communications system 100 that supports channel state information feedback based on full channel estimation in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more subbands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a UE 115 may receive a set of beamformed reference signals from a base station 105. UE 115 may receive the set of beamformed reference signals via a set of receive beams of UE 115. In some cases, each beamformed reference signal of the set of beamformed reference signals may be associated with (e.g., transmitted via) a corresponding transmit beam of a set of transmit beams of base station 105. In some cases, UE 115 may determine a channel matrix representative of a communications channel between UE 115 and base station 105. UE 115 may determine the channel matrix based on the set of beamformed reference signals. In some cases, UE 115 may transmit channel state information to base station 105. The channel state information may be representative of the raw communications channel between the base station 105 and the UE 115 (e.g., based on the channel matrix).

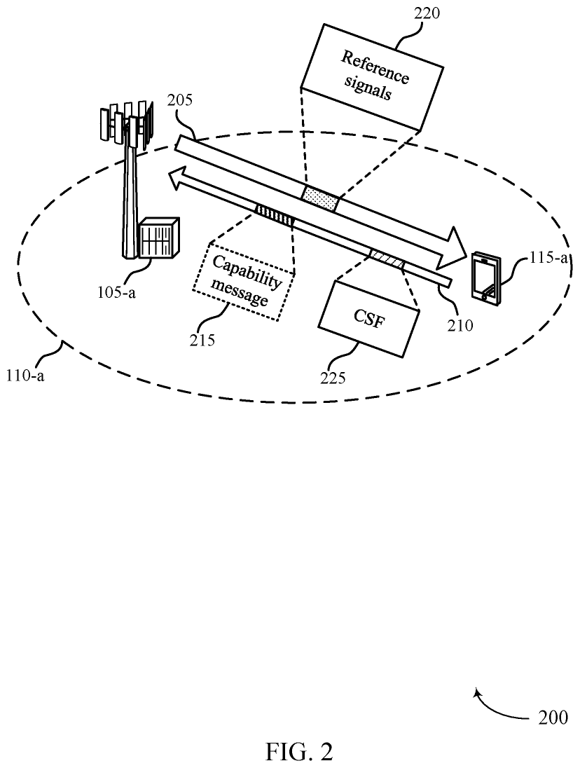

FIG. 2 illustrates an example of a wireless communications system 200 that supports channel state information feedback based on full channel estimation in accordance with aspects of the present disclosure. In some examples, some aspects of wireless communications system 200 may implement or be implemented by aspects of wireless communications system 100. For example, wireless communications system 200 may include a base station 105-a and UE 115-a, which may be examples of a base station 105 and a UE 115 described with reference to FIG. 1.

As illustrated, wireless communications system 200 may include UE 115-a (e.g., a receive device) and base station 105-a (e.g., a transmit device), which may be examples of a UE 115 or a base station 105, as described above with reference to FIG. 1. Wireless communications system 200 may also include downlink 205 and uplink 210. Base station 105-a may use downlink 205 to convey control and/or data information to UE 115-a. And UE 115-a may use uplink 210 to convey control and/or data information to base station 105-a. In some cases, downlink 205 may use different time and/or frequency resources than uplink 210. As depicted, base station 105-a may be associated with geographic coverage area 110-a in which communications with one or more UEs (e.g., UE 115-a) is supported.

In the illustrated example, UE 115-a may transmit one or more transmissions to base station 105-a. In some cases, the one or more transmissions from UE 115-a may optionally include UE 115-a transmitting a capability message 215 to base station 105-a. In some cases, the capability message 215 may indicate that UE 115-a is capable of determining a channel matrix representative of a communications channel (e.g., at millimeter wave frequencies).

In the illustrated example, UE 115-a may receive one or more transmissions from base station 105-a. In some cases, the one or more transmissions from base station 105-a may include reference signals 220 (e.g., a set of beamformed reference signals). In some cases, reference signals 220 may be based on millimeter wave frequencies. As shown, UE 115-a may receive reference signals 220 from base station 105-a. UE 115-a may receive the reference signals 220 via a set of receive beams of UE 115-a. In some cases, each beamformed reference signal of reference signals 220 may be associated with a corresponding transmit beam of a set of transmit beams of base station 105-a. In some cases, UE 115-a may determine a channel matrix representative of a communications channel between UE 115-a and base station 105-a. In some cases, UE 115-a may determine the channel matrix based on reference signals 220.

In the illustrated example, UE 115-a may transmit channel state feedback 225 (e.g., channel state information) to base station 105-a. The channel state feedback 225 may be based on the channel matrix that UE 115-a determines and that is representative of the communications channel between UE 115-a and base station 105-a. In some cases, the channel state feedback 225 (e.g., channel state information) may be independent of each (e.g., not specific to any) receive beam of the set of receive beams of UE 115-a and independent of each (e.g., not specific to any) transmit beam of the set of transmit beams of base station 105-a.

In some cases, UE 115-a may transmit the channel state information based on one or more triggering conditions. In some cases, the triggering conditions may be based on a power level of UE 115-a, a signal quality associated with UE 115-a, or a power level of a signal associated with UE 115-a, or any combination thereof. In some cases, a power level of UE 115-a satisfying a power level threshold (e.g., power level of UE 115-a is less than, less than or equal to, greater than, or greater than or equal to the power level threshold) may trigger UE 115-a transmitting channel state feedback 225 based on the channel matrix. In some cases, a signal quality of UE 115-a satisfying a signal quality threshold (e.g., signal quality of UE 115-a is less than, less than or equal to, greater than, or greater than or equal to the signal quality threshold) may trigger UE 115-a transmitting channel state feedback 225 based on the channel matrix. In some cases, a power level of a signal of UE 115-a satisfying a signal power threshold (e.g., power level of a signal of UE 115-a is less than, less than or equal to, greater than, or greater than or equal to the signal power threshold) may trigger UE 115-a transmitting channel state feedback 225 based on the channel matrix.

In some examples, UE 115-a transmitting the channel state information may include UE 115-a transmitting a compressed representation of the channel matrix. In some cases, UE 115-a may use machine learning or a neural network, or both, to obtain the compressed representation of the channel matrix. In some cases, base station 105-a may receive the compressed representation of the channel matrix and decompress the compressed representation of the channel matrix. In some cases, base station 105-a may use machine learning or a neural network, or both, to decompress the compressed representation of the channel matrix.

In some examples, UE 115-a transmitting the channel state information may include UE 115-a transmitting a precoding matrix indicator that is independent of the set of receive beams, the rank indicator may be independent of the set of receive beams, or the channel quality indicator may be independent of the set of receive beams, or any combination thereof. For example, the precoding matrix indicator, the rank indicator, or the channel quality indicator may not be specific to any one beam of the set of receive beams. The precoding matrix indicator, the rank indicator, or the channel quality indicator may be independent of a codebook associated with the set of receive beams. Additionally or alternatively, the precoding matrix indicator, the rank indicator, or the channel quality indicator may be independent of the set of transmit beams (e.g., not specific to any one beam of the set of transmit beams, independent of a codebook associated with the set of transmit beams, or both).

For frequency-selective channels, the channel may be a function of frequency (e.g., channel conditions and characteristics may vary across frequencies). Accordingly, in some examples, UE 115-a may determine a channel matrix that is specific to a subband. For example, the UE 115-a may determine multiple channel matrices, each specific to a respective subband and transmit channel state information for each of the subbands based on the corresponding subband-specific channel matrices. Thus, UE 115-a may determine one or more channel matrices on a per-subband basis and may likewise transmit per-subband channel state information (e.g., channel state information that is specific to a subband and based on a corresponding channel matrix that is specific to the subband) to the base station 105-a. Thus, in some cases, signaling the channel matrix to the base station 105-a may include transmitting channel state information based on a first channel matrix for a first subband, transmitting channel state information based on a second channel matrix for a second subband, and so on.

In some cases, a size of at least one dimension of the channel matrix may be based on a total quantity of receive antenna ports of UE 115-a, or a total quantity of transmit antenna ports of base station 105-a, or a combination of both. In some cases, a size of a first dimension of the channel matrix is equal to the total quantity of receive antenna ports of UE 115-a, and a size of a second dimension of the channel matrix is equal to the total quantity of transmit antenna ports of base station 105-a.

In some cases, UE 115-a may receive configuration information from base station 105-a. In some cases, the configuration information (e.g., channel matrix configuration) may indicate resources for UE 115-a. In some cases, the configuration information may indicate one or more aspects of reference signals 220. In some cases, the one or more aspects of reference signals 220 may include randomly selected beam directions, pseudo-randomly selected beam directions, machine learning selected beam directions, measurement beams not included in a codebook, or any combination thereof. In some cases, the configuration information may indicate resources (e.g., time resources, frequency resources) for UE 115-a to receive reference signals 220 to determine the channel matrix. In some cases, the configuration information may indicate resources for UE 115-a to transmit the channel state feedback 225 based on the channel matrix. In some cases, the configuration information may include resources for UE 115-a transmit one or more contents of channel state information based on the channel matrix, where the channel state feedback 225 includes the one or more contents of channel state information.

In some examples, the set of transmit beams of base station 105-a may correspond to a codebook. In some cases, the set of receive beams of UE 115-a may correspond to a codebook (e.g., the same codebook corresponding the set of transmit beams of base station 105-a). In some cases, UE 115-a and base station 105-a may communicate with each other based on the channel state feedback 225. In some cases, UE 115-a may use a receive beam to communicate with base station 105-a, where the receive beam is generated based on the channel matrix and is outside the set of receive beams of UE 115-a (e.g., generated independent of the set of receive beams of the codebook of UE 115-a, not within a UE beam codebook previously used for communication, etc.). In some cases, base station 105-a may use a transmit beam to communicate with UE 115-a, where the transmit beam is generated based on the channel matrix and is outside the set of transmit beams of base station 105-a (e.g., generated independent of the set of transmit beams of the codebook of base station 105-a).

The described techniques support increased system efficiency based on a device supporting channel state information feedback based on full channel estimation. Additionally, described techniques result in avoiding multiple retransmissions and failed transmissions, decreasing system latency, improving the reliability of data decoding, and improving user experience. Accordingly, the present techniques provide increased signal quality, throughput, and reliability for communications between base station 105-a and UE 115-a.

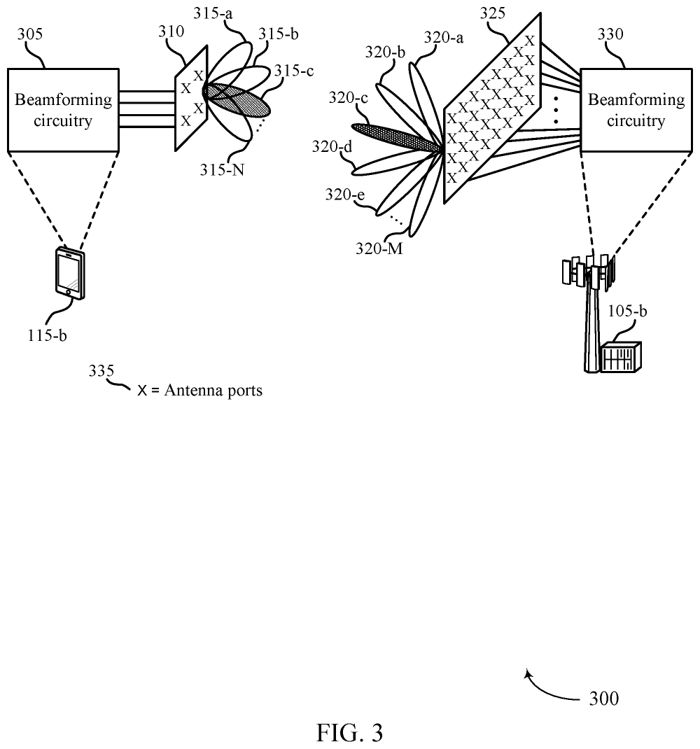

FIG. 3 illustrates an example of a wireless communications system 300 that supports channel state information feedback based on full channel estimation in accordance with aspects of the present disclosure. In some examples, some aspects of wireless communications system 300 may implement or be implemented by aspects of wireless communications system 100. For example, wireless communications system 300 may include a base station 105-b and UE 115-b, which may be examples of a base station 105 and a UE 115 described with reference to FIG. 1 or FIG. 2.

Base station 105-b may transmit signals to UE 115-b using one or more transmit beams 320. For example, base station 105-b may use one or more beams of a set of transmit beams that ranges from a transmit beam 320-a to a transmit beam 320-M (e.g., M transmit beams, M being a positive integer), where each transmit beam 320 may be associated with a respective direction (e.g., one or more respective directional qualities, such as an angle relative to an antenna panel 325). UE 115-b may receive (e.g., attempt to receive, monitor for) signals from base station 105-b using one or more receive beams 315. For example, UE 115-b may use one or more beams of a set of receive beams ranging from a receive beam 315-a to a receive beam 315-N (e.g., N receive beams, N being a positive integer), where each receive beam 315 may be associated with a respective direction (e.g., one or more respective directional qualities, such as an angle relative to an antenna panel 310). While some quantities of beams (e.g., transmit beams 320 and/or receive beams 315) are described herein, it is understood that the examples described herein may apply to any number of transmit beams 320 or receive beams 315 without departing from the scope of the present disclosure.

Base station 105-b and UE 115-b may transmit beamformed signals (e.g., may shape beams for reception or transmission) using a respective antenna panel 310 and 325. For example, UE 115-b may include or be coupled with antenna panel 310, which may be associated with an array of antenna ports 335.

Each illustrated antenna port 335 may, for example, represent one or more antenna ports 335. For example, in some cases, each antenna port 335 illustrated in FIG. 2 may be a dual polarized antenna element, where each antenna port 335 represents two poles within the antenna array. In the given example, each of the four antenna ports 335 at antenna panel 310 may each have two poles, where a first pole is based on a first polarity (e.g., a horizontal polarity), and a second pole is based on a second polarity (e.g., a vertical polarity). Thus, in the illustrated example, the number of receive antenna ports (e.g., N_{Rx}) of antenna panel 310 may include eight antenna ports 335 (e.g., N_{Rx} equals four antenna ports 335 of the first polarity and four antenna ports 335 of the second polarity). In the given example, each of the 32 antenna ports 335 at antenna panel 325 may each have two poles, where a first pole is based on a first polarity (e.g., a horizontal polarity), and a second pole is based on a second polarity (e.g., a vertical polarity). Thus, in the illustrated example, the number of transmit antenna ports (e.g., N_{Tx}) of antenna panel 325 may include 64 antenna ports 335 (e.g., N_{Tx} equals 32 antenna ports 335 of the first polarity and 32 antenna ports 335 of the second polarity). It is understood that these and any other specific numeric quantities described herein are merely examples provided for illustrative purposes and are not limiting of the claims.

In the illustrated example, UE 115-b and base station 105-b may each include beamforming circuitry 305 and 330, respectively. In some cases, beamforming circuitry 305 or beamforming circuitry 330, or both, may include circuitry to generate transmit beams, or generate receive beams, or generate both. In some cases, beamforming circuitry 305 or beamforming circuitry 330, or both, may include one or more analog beamformers configured to generate analog receive beams or analog transmit beams, or both. In some cases, beamforming circuitry 305 or beamforming circuitry 330, or both, may include one or more analog to digital converters to convert analog beams to digital. In some cases, beamforming circuitry 305 or beamforming circuitry 330, or both, may include one or more digital beamformers to digitize converted beams. In some cases, beamforming circuitry 305 or beamforming circuitry 330, or both, may include one or more digital precoders to generate transmit beams. In some cases, beamforming circuitry 305 or beamforming circuitry 330, or both, may include one or more digital to analog converters to convert the digital transmit beams to analog transmit beams.

In some examples, beamforming circuitry 305 or beamforming circuitry 330, or both, may include one or more transceivers, which may be used to process signals for transmission or reception at the corresponding device (e.g., in conjunction with or including the respective antenna panels 310 and 325). Each transceiver may include one or more components associated with transmission and reception of wireless signals (e.g., one or more radio frequency (RF) chains, beamforming components. antenna modules). UE 115-b and base station 105-b may use a respective transceiver (e.g., a millimeter wave transceiver) to perform analog or hybrid beamforming. The beamforming may be performed using a RF, or at an intermediate frequency (IF), using a bank of phase shifters (e.g., one phase shifter per antenna element of a respective antenna panel 310 and 325).

In some examples (e.g., for millimeter wave frequencies), transmit- and receive-beamformed transmissions may be implemented between UE 115-b and base station 105-b based on the relatively high attenuation of millimeter wave frequencies. In some cases, analog beamforming at base station 105-b and UE 115-b and the input-output relationship per tone (e.g., sub-carrier) for downlink, y, may be defined as y=AHBPx+n, where H is the raw channel (e.g., full channel matrix) where H=N_{Rx}×N_{Tx} (e.g., 8×64); A is a receive (e.g., analog) beamforming matrix, A=N_{RP}×N_{Rx} (e.g., 2×8); B is a transmit (e.g., analog) beamforming matrix, B=N_{Tx}×N_{TP} (e.g., 64×2); and P is a transmit (e.g., digital) precoding matrix, P=N_{TP}×N_{SS}. In some examples, multiplying AHB results in a 2×2 channel (e.g., based on matrix multiplication), or one of the multiple observed channels. In some cases, H may be based be a function of core parameters such as a number of clusters and per-cluster relative to an associated azimuth angles of arrival (AOA), azimuth angles of departure (AOD), zenith angles of arrival (ZOA), zenith angles of departure (ZOD), transmission delay, or transmission power, or any combination thereof.

In some examples, A and B may be chosen based on an analog beamforming codebook (e.g., a set of phase shifts applied to antenna elements, a set of phase shifts applied to amplitude coefficients, etc.). In some cases (e.g., for downlink), A may be chosen by UE 115-b. In some cases, B and P may be chosen by base station 105-b. In some cases, A may be associated with beamforming circuitry 305, H may represent the channel between receive beams 315 and transmit beams 320, while B and P may be associated with beamforming circuitry 330.

Using a series of consecutive transmit- and receive-beamformed channel measurements (e.g., series of channel measurements for combinations of the N receive beams 315 and M transmit beams 320, [A_{N}, B_{M}]), UE 115-b may construct the underlying raw channel (e.g., based on a millimeter wave channel being sparse). In some cases, UE 115-b may construct the underlying raw channel based on compressed sensing approaches or machine learning-based approaches. The series of channel measurements for combinations of the N receive beams 315 and M transmit beams 320 may include multiple transmit/receive beam pair combinations for each receive beam 315. In some cases, the series of channel measurements for combinations of the N receive beams 315 and M transmit beams 320 may include beam pair combinations for receive beam 315-c. The beam pair combinations for receive beam 315-c included in the series of channel measurements may include [315-c, 320-a], [315-c, 320-b], [315-c, 320-c], [315-c, 320-d], [315-c, 320-e], or [315-c, 320-M], or any combination thereof.

In some examples, UE 115-b may construct the underlying raw channel based on the series of channel measurements (e.g., series of 2×2 beamformed channel measurements). Each measurement may be referred to as a 2×2 beamformed channel measurement based on each antenna port 335 of antenna panel 310 or antenna panel 325 being dual-polarized (e.g., beamformed channel measurement of beam pair [315-c, 320-c] is a [2×2] beamformed channel measurement).

Assuming N total receive beams 315 and M total transmit beams 320, there are NM total possible beam pairs for UE 115-b to measure from. In the illustrated example, NM=8×64=512 based on the dual-polarized antenna ports 335. The number of beam pair measurements for raw channel construction may be smaller or larger than this number depending on the sparsity of the channel H. In some cases, UE 115-b or base station 105-b, or both, may select which beam pairs to measure for raw channel construction. The selection of which beam pairs to measure for the purpose of raw channel construction may be done in a random or pseudorandom manner.

In some examples, UE 115-b may feedback enhanced channel state feedback for the underlying raw channel (e.g., H at millimeter wave frequencies). In some cases, UE 115-b may indicate a capability of raw channel construction at millimeter wave frequencies. When base station 105-b is aware of this capability of UE 115-b (e.g., based on one or more triggering conditions), base station 105-b may configure UE 115-b to receive reference signals in a configured manner to enable UE 115-b to perform raw channel construction. In some cases, the triggering conditions may trigger base station 105-b to select whether to use beamformed or non-beamformed transmissions. In some cases, base station 105-b selecting beamformed transmissions may enable UE 115-b to perform raw channel construction. Thus, in some cases, the triggering conditions may trigger raw channel construction. In some cases, the triggering conditions may be based on a signal quality condition or a signal power level, or both, associated with UE 115-b. In some cases, the triggering conditions may be based on the signal quality condition satisfying a threshold (e.g., meets or exceeds a quality threshold). In some cases, the triggering conditions may be based on the power level satisfying a threshold (e.g., meets or exceeds a power threshold). In some cases, the better the signal to noise ratio or power level, or both, the better the raw channel estimation. In some cases, raw channel construction may be performed independent of the signal quality condition or independent of the power level, or independent of both.

After UE 115-b performs raw channel estimation, UE 115-b may send enhanced channel state feedback (e.g., based on the series of beamformed channel measurements) to base station 105-b. In some cases, UE 115-b may compute the (PMI), a rank indicator (RI), or a channel quality indicator (CQI) based on the series of beamformed channel measurements. In some cases, the enhanced channel state feedback may be based on the PMI, RI, or CQI, or any combination thereof.

After UE 115-b performs raw channel estimation, UE 115-b may compress at least a portion of the raw channel estimation. In some cases, UE 115-b may divide the raw channel estimation into two or more separate portions of the raw channel estimation, compress one or more portions of the raw channel estimation, and transmit the one or more compressed portions of the raw channel estimation to base station 105-b. In some cases, UE 115-b may transmit at least one uncompressed portion of the raw channel estimation to base station 105-b.

In some examples, the enhanced channel state feedback may have a dedicated channel state information (CSI) resource configuration (e.g., CSIResourceConfig), or a dedicated CSI report configuration (e.g., CSIReportConfig), or both. In some cases, the CSI resource configuration or CSI report configuration, or both, may be in addition to the enhanced channel state feedback for the beamformed channel.

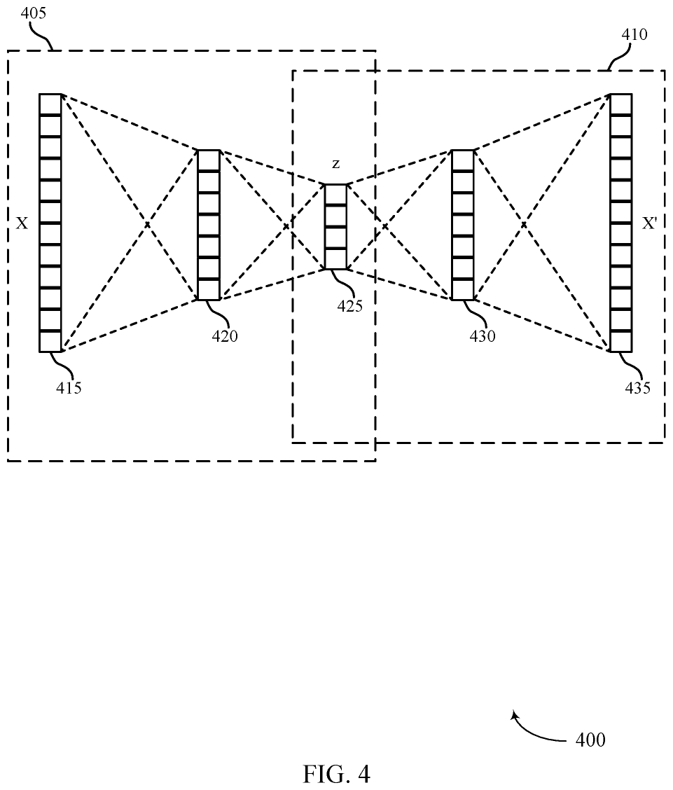

FIG. 4 illustrates an example of an autoencoder 400 that supports channel state information feedback based on full channel estimation in accordance with aspects of the present disclosure. In some examples, some aspects of autoencoder 400 may implement or be implemented by aspects of wireless communications system 100. For example, a base station 105 or UE 115 (e.g., a base station 105 or UE 115 described with reference to FIG. 1, 2, or 3), or both, may include an instance of autoencoder 400.

In the illustrated example, autoencoder 400 may include an encoder decoder network that includes encoder 405 and decoder 410. In some cases, the encoder 405 and decoder 410 may be trained jointly, but deployed separately (e.g., encoder 405 implemented in a UE 115 and decoder 410 implemented in a base station 105, or vice versa). In some cases, encoder 405 and decoder 410 may be deployed together on one or more devices (e.g., encoder 405 and decoder 410 implemented in a UE 115 and encoder 405 and decoder 410 implemented in a base station 105). As shown, encoder 405 may include input data 415 (e.g., input data X), intermediary compressed data 420, and compressed data 425 (e.g., lower-dimensional representation z). In the illustrated example, decoder 410 may include compressed data 425 (e.g., lower-dimensional representation z), intermediary decompressed data 430, and reconstructed input data 435 (e.g., reconstructed input data X′).

In some examples, autoencoder 400 may implement multi-block machine learning techniques that include at least a backbone block and a task-specific block (e.g., backbone block and task-specific block of autoencoder 400) based on the UE 115 transmitting capability information indicating a capability of the UE 115 to support an end-to-end multi-block machine learning application, including a first UE capability corresponding to a supported backbone block of the multi-block machine learning application that makes up one or more front-end layers (e.g., one or more backbone layers) and a second UE capability corresponding to a supported task-specific block of the multi-block machine learning application that makes up the end layer(s) of the end-to-end model (e.g., one or more task-specific layers). For the reported backbone block UE capability, the UE 115 may indicate machine learning model types of a backbone block that are supported (e.g., convolutional neural network (CNN), fully connected (FC) network, long short-term memory (LSTM) network, transformer network, etc.), a level of the model size that is supported (e.g., kilobyte (KB) level, megabyte (MB) level, 10 MB level, etc.), a level of the operations that is supported (e.g., 1 k flops, 10 k flops, 100 k flops, etc.). For the reported task-specific block UE capability, the UE may indicate what tasks the UE supports, what scenarios the UE supports, etc.

In some cases, UE 115 may use one or more multi-block machine learning applications (e.g., of autoencoder 400), each of which may include a backbone block and one or more task-specific block. For example, a backbone block and a task-specific block may be combined as a single multi-block machine learning application model or configuration (e.g., of autoencoder 400). In some examples, a multi-block machine learning application may be built by the UE 115 and the base station 105 working jointly (e.g., as a neural network, such as a deep neural network). For example, to build a machine learning application for channel state feedback reporting, the UE 115 may implement encoder 405 in a neural network and the base station 105 may implement decoder 410 in the neural network. In some cases, encoder 405 (e.g., of UE 115) may use the characteristics of an estimated channel as input features for the machine learning and the UE 115 may communicate feedback generated by the machine learning to the base station 105. In some cases, decoder 410 (e.g., of base station 105) may output latent code based on the feedback. In some cases, different channel types may be associated with different task-specific blocks.

After determining a raw channel (e.g., channel matrix of the raw channel), a UE 115 may compress the channel (e.g., using a neural network such as autoencoder 400) and send the embedded representation of the channel over the air to a base station 105. In some cases, the base station 105 may receive the embedded representation of the channel and use decoder 410 of autoencoder 400 to recover the raw channel. For pairwise compression implementations (e.g., compression in relation to measured beam pairs), a signaling framework may be defined (e.g., by the base station 105, by the UE 115, etc.) through which a transmit device and receive device (e.g., base station 105 and UE 115, respectively) may interact for machine learning module updates, parameter exchanges, joint training, etc., in relation to autoencoder 400.

In some examples, the autoencoder 400 may use machine learning to analyze training data (e.g., an uncompressed channel matrix, a corresponding compressed channel matrix, a corresponding decompressed channel matrix, etc.). In some cases, autoencoder 400 may learn compression techniques based on the training data, instead of implementing a fixed compression algorithm. In some cases, the autoencoder 400 may learn the structure of uncompressed data, compressed data, and decompressed data based on the training and analysis. In some cases, the autoencoder 400 may customize compression and decompression for a given type of data (e.g., measured beam pairs) based on the analysis. In some cases, the autoencoder 400 may identify relationships between uncompressed training data and compressed training data, or relationships between compressed training data and decompressed training data, or both, based on the analysis. In some cases, the customized compression and decompression may be based on the identified relationships between compressed training data and decompressed training data.

In some examples, encoder 405 may include a non-supervised encoding learning algorithm in which encoder 405 computes compressed data 425 (e.g., relatively low-dimension representation z of input X) from input 415 (e.g., input data X, at least a portion of a constructed full channel matrix). In some cases, encoder 405 may first compute intermediary compressed data 420 from input 415, and then compute compressed data 425 from intermediary compressed data 420. In some cases, compressed data 425 (e.g., the relatively low-dimension representation z) may be referred to as a bottleneck layer. In some cases, the bottleneck layer may carry fundamental information of input 415 to enable an approximate construction of input 415 from the bottleneck layer.

In some examples, the UE 115 may transmit compressed data 425 (e.g., the relatively low-dimension representation z) to the base station 105. In some cases, the base station 105 may include decoder 410 configured to decode compressed data 425 (e.g., the relatively low-dimension representation z). In some cases, the decoder 410 may include a non-supervised decoding learning algorithm in which the decoder 410 computes constructed input data 435 (e.g., constructed input data X′ that decoder 410 constructs from the relatively low-dimension representation z). In some cases, decoder 410 may first compute intermediary decompressed data 430 from compressed data 425, and then compute constructed input data 435 from intermediary decompressed data 430.

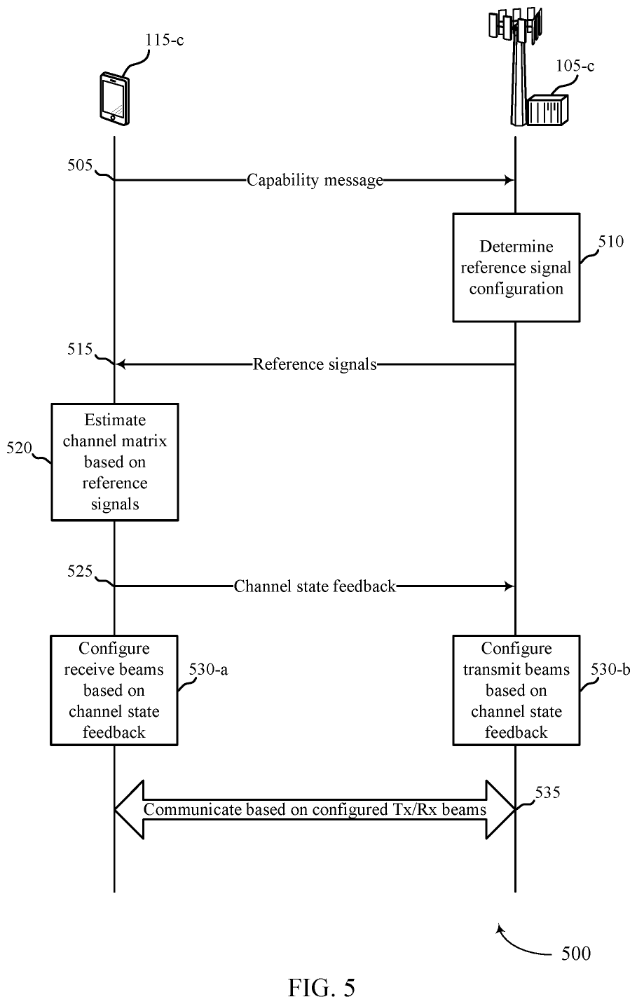

FIG. 5 illustrates an example of a process flow 500 that supports channel state information feedback based on full channel estimation in accordance with aspects of the present disclosure. In some examples, some aspects of process flow 500 may implement or be implemented by aspects of wireless communications system 100. For example, process flow 500 may include a base station 105-c and UE 115-c, which may be examples of a base station 105 and a UE 115 described with reference to FIG. 1, 2, or 3.

At 505, UE 115-c may transmit a capability message to base station 105-c. In some cases, the capability message may indicate that UE 115-c is capable of determining a channel matrix representative of a communications channel (e.g., at millimeter wave frequencies). In some cases, the capability message may indicate a capability of the UE 115-c to support an end-to-end multi-block machine learning application (e.g., autoencoder 400).

At 510, base station 105-c may determine a configuration of reference signals (e.g., a set of beamformed reference signals) based on the capability message. In some cases, the reference signals may be configured based on millimeter wave frequencies. In some cases, the configuration of reference signals may include at least beam direction, beam frequencies (e.g., millimeter wave frequencies), phase shifter coefficients, or amplitude coefficients, or any combination thereof. In some cases, base station 105-c may transmit a configuration message that indicates the configuration of the reference signals.

At 515, base station 105-c may transmit the configured reference signals to UE 115-c. In some cases, UE 115-c may configure receive beams to receive the reference signals based on the configuration of reference signals.

At 520, UE 115-c may determine (e.g., estimate) a channel matrix representative of a communications channel between UE 115-c and base station 105-c. In some cases, UE 115-c may determine the channel matrix based on the configured reference signals.

At 525, UE 115-c may transmit channel state feedback (e.g., channel state information) to base station 105-c. The channel state feedback may be based on the channel matrix determined by UE 115-.

At 530, base station 105-c may configure transmit beams based on the channel state feedback (e.g., channel matrix) of UE 115-c. In some cases, base station 105-c may configure transmit beamformer settings or transmit precoder settings, or both, based on the channel state feedback. In some cases, at 530, UE 115-c may configure receive beams to communicate with base station 105-c based on the channel state feedback (e.g., channel matrix). In some cases, UE 115-c may configure receive beamformer settings based on the channel state feedback.

At 535, UE 115-c and base station 105-c may communicate with each other based on the respective transmit beams and receive beams configured according to the channel state feedback. In some cases, the respective transmit beams and receive beams may be outside (e.g., independent of) a set of transmit/receive beam pairs of a codebook associated with UE 115-c and base station 105-c.

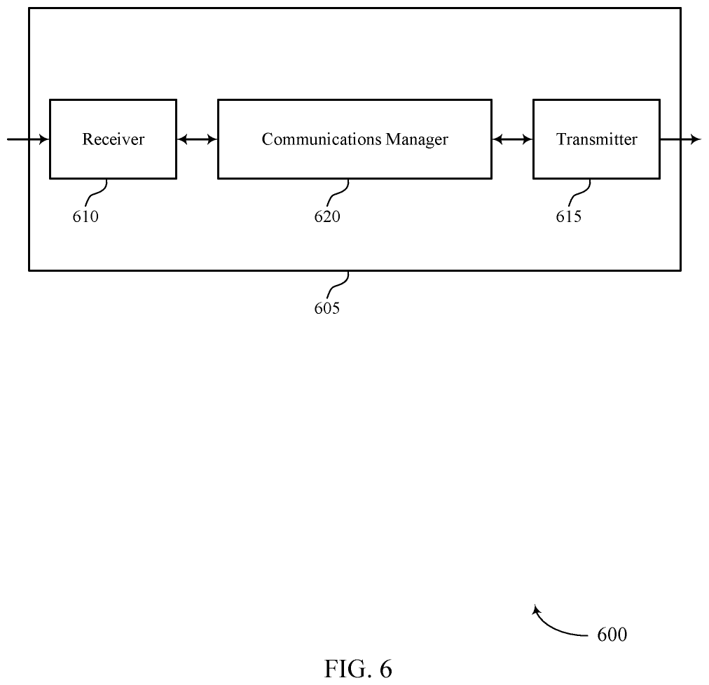

FIG. 6 shows a block diagram 600 of a device 605 that supports channel state information feedback based on full channel estimation in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to channel state information feedback based on full channel estimation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to channel state information feedback based on full channel estimation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of channel state information feedback based on full channel estimation as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a receive device in accordance with examples as disclosed herein. For example, the communications manager 620 may be configured as or otherwise support a means for receiving a set of beamformed reference signals from a transmit device via a set of receive beams of the receive device, each beamformed reference signal of the set of beamformed reference signals associated with a corresponding transmit beam of a set of transmit beams of the transmit device. The communications manager 620 may be configured as or otherwise support a means for determining, based on the set of beamformed reference signals, a channel matrix representative of a communications channel between the receive device and the transmit device. The communications manager 620 may be configured as or otherwise support a means for transmitting, to the transmit device, channel state information based on the channel matrix.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for channel state information feedback based on full channel estimation. The described techniques result in reduced processing, reduced power consumption, more efficient utilization of communication resources. Accordingly, the present techniques provide increased signal quality, throughput, and reliability for communications of device 605.

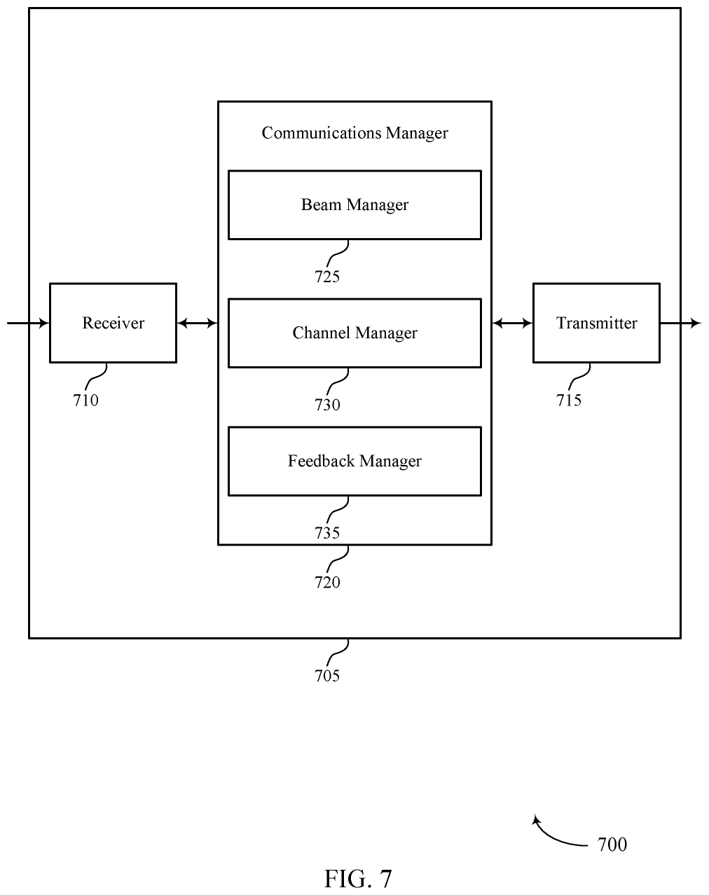

FIG. 7 shows a block diagram 700 of a device 705 that supports channel state information feedback based on full channel estimation in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to channel state information feedback based on full channel estimation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to channel state information feedback based on full channel estimation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of channel state information feedback based on full channel estimation as described herein. For example, the communications manager 720 may include a beam manager 725, a channel manager 730, a feedback manager 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a receive device in accordance with examples as disclosed herein. The beam manager 725 may be configured as or otherwise support a means for receiving a set of beamformed reference signals from a transmit device via a set of receive beams of the receive device, each beamformed reference signal of the set of beamformed reference signals associated with a corresponding transmit beam of a set of transmit beams of the transmit device. The channel manager 730 may be configured as or otherwise support a means for determining, based on the set of beamformed reference signals, a channel matrix representative of a communications channel between the receive device and the transmit device. The feedback manager 735 may be configured as or otherwise support a means for transmitting, to the transmit device, channel state information based on the channel matrix.

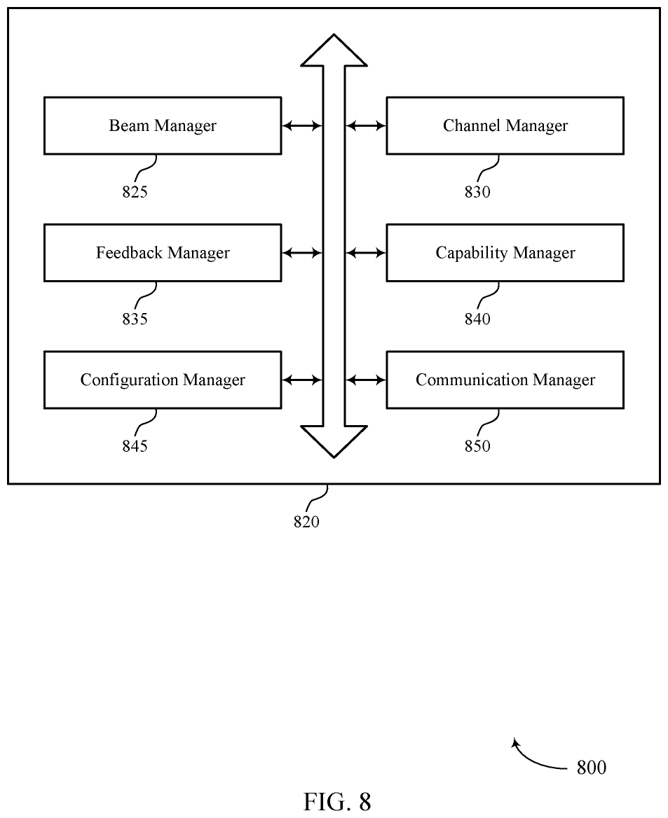

FIG. 8 shows a block diagram 800 of a communications manager 820 that supports channel state information feedback based on full channel estimation in accordance with aspects of the present disclosure. The communications manager 820 may be an example of aspects of a communications manager 620, a communications manager 720, or both, as described herein. The communications manager 820, or various components thereof, may be an example of means for performing various aspects of channel state information feedback based on full channel estimation as described herein. For example, the communications manager 820 may include a beam manager 825, a channel manager 830, a feedback manager 835, a capability manager 840, a configuration manager 845, a communication manager 850, or any combination thereof. Each of these components may communicate, directly or indirectly, with one another (e.g., via one or more buses).

The communications manager 820 may support wireless communication at a receive device in accordance with examples as disclosed herein. The beam manager 825 may be configured as or otherwise support a means for receiving a set of beamformed reference signals from a transmit device via a set of receive beams of the receive device, each beamformed reference signal of the set of beamformed reference signals associated with a corresponding transmit beam of a set of transmit beams of the transmit device. The channel manager 830 may be configured as or otherwise support a means for determining, based on the set of beamformed reference signals, a channel matrix representative of a communications channel between the receive device and the transmit device. The feedback manager 835 may be configured as or otherwise support a means for transmitting, to the transmit device, channel state information based on the channel matrix.

In some examples, to support transmitting the channel state information, the feedback manager 835 may be configured as or otherwise support a means for transmitting a compressed representation of the channel matrix. In some examples, the feedback manager 835 may be configured as or otherwise support a means for using machine learning or a neural network, or both, to obtain the compressed representation of the channel matrix. In some examples, transmitting the channel state information based on the channel matrix is based on a power level of the receive device, a signal quality associated with the receive device, or a power level of a signal associated with the receive device, or any combination thereof.

In some examples, to support transmitting the channel state information, the feedback manager 835 may be configured as or otherwise support a means for transmitting a precoding matrix indicator that is applicable to or representative of the set of receive beams, a rank indicator that is applicable to or representative of the set of receive beams, or a channel quality indicator that is applicable to or representative of the set of receive beams, or any combination thereof. In some cases, the precoding matrix indicator may be independent of the set of receive beams, the rank indicator may be independent of the set of receive beams, or the channel quality indicator may be independent of the set of receive beams, or any combination thereof.

In some examples, the channel matrix and the channel state information may be specific to a first subband. The beam manager 825 may be configured as or otherwise support a means for receiving a second set of beamformed reference signals from the transmit device via the set of receive beams, the second set of beamformed reference signals within a second subband. The channel manager 830 may be configured as or otherwise support a means for determining, based on the second set of beamformed reference signals, a second channel matrix that is specific to the second subband and representative of a second communications channel between the receive device and the transmit device within the second subband. The feedback manager 835 may be configured as or otherwise support a means for transmitting, to the transmit device, second channel state information based on the second channel matrix.

In some examples, a size of at least one dimension of the channel matrix is based on a total quantity of receive antenna ports of the receive device, or a total quantity of transmit antenna ports of the transmit device, or both. In some examples, a size of a first dimension of the channel matrix is equal to the total quantity of receive antenna ports of the receive device. In some examples, a size of a second dimension of the channel matrix is equal to the total quantity of transmit antenna ports of the transmit device. In some examples, the channel state information is independent of each receive beam of the set of receive beams and each transmit beam of the set of transmit beams.

In some examples, the capability manager 840 may be configured as or otherwise support a means for transmitting, to the transmit device, a capability message indicating that the receive device is capable of determining the channel matrix representative of the communications channel.

In some examples, the configuration manager 845 may be configured as or otherwise support a means for receiving, from the transmit device, configuration information indicating resources for receiving the set of beamformed reference signals to determine the channel matrix, resources for transmitting the channel state information based on the channel matrix, or one or more contents of the channel state information based on the channel matrix, or any combination thereof.

In some examples, the communication manager 850 may be configured as or otherwise support a means for communicating with the transmit device, after transmitting the channel state information, using a receive beam that is independent of a codebook associated with the set of receive beams (e.g., not within a UE beam codebook previously used for communication) and generated based on the channel matrix.

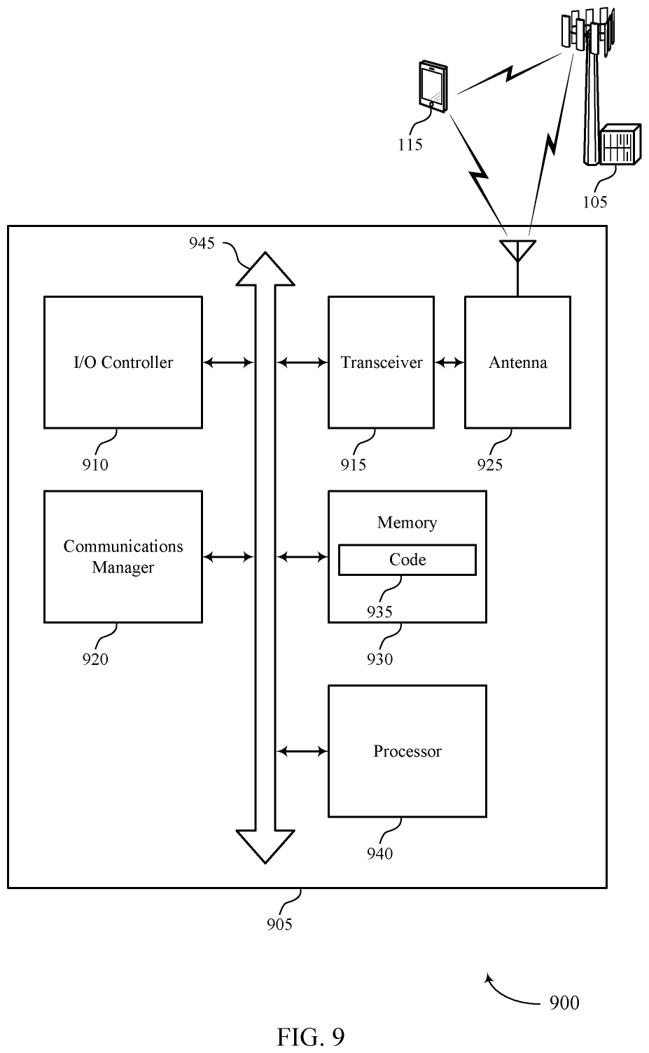

FIG. 9 shows a diagram of a system 900 including a device 905 that supports channel state information feedback based on full channel estimation in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output

(I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting channel state information feedback based on full channel estimation). For example, the device 905 or a component of the device 905 may include a processor 940 and memory 930 coupled to the processor 940, the processor 940 and memory 930 configured to perform various functions described herein.

The communications manager 920 may support wireless communication at a receive device in accordance with examples as disclosed herein. For example, the communications manager 920 may be configured as or otherwise support a means for receiving a set of beamformed reference signals from a transmit device via a set of receive beams of the receive device, each beamformed reference signal of the set of beamformed reference signals associated with a corresponding transmit beam of a set of transmit beams of the transmit device. The communications manager 920 may be configured as or otherwise support a means for determining, based on the set of beamformed reference signals, a channel matrix representative of a communications channel between the receive device and the transmit device. The communications manager 920 may be configured as or otherwise support a means for transmitting, to the transmit device, channel state information based on the channel matrix.

By including or configuring the communications manager 920 in accordance with examples as described herein, the device 905 may support techniques for channel state information feedback based on full channel estimation. The described techniques result in improved communication reliability, reduced latency, improved user experience related to reduced processing, reduced power consumption, more efficient utilization of communication resources, improved coordination between devices, longer battery life, improved utilization of processing capability. Accordingly, the present techniques provide increased signal quality, throughput, and reliability for communications of device 905.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of channel state information feedback based on full channel estimation as described herein, or the processor 940 and the memory 930 may be otherwise configured to perform or support such operations.

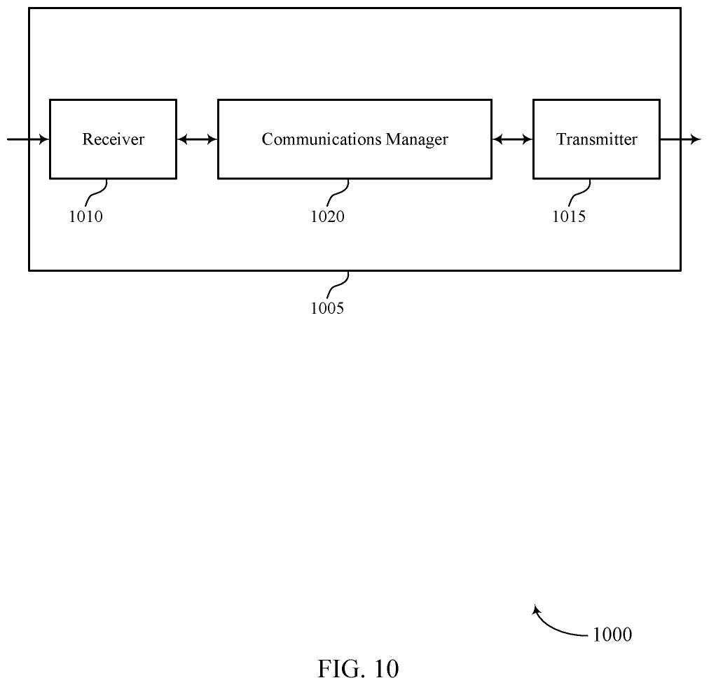

FIG. 10 shows a block diagram 1000 of a device 1005 that supports channel state information feedback based on full channel estimation in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to channel state information feedback based on full channel estimation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to channel state information feedback based on full channel estimation). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of channel state information feedback based on full channel estimation as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a transmit device in accordance with examples as disclosed herein. For example, the communications manager 1020 may be configured as or otherwise support a means for transmitting a set of beamformed reference signals to a receive device via a set of transmit beams of the transmit device, each beamformed reference signal of the set of beamformed reference signals associated with a corresponding receive beam of a set of receive beams of the receive device. The communications manager 1020 may be configured as or otherwise support a means for receiving channel state information from the receive device based on a channel matrix, where the channel matrix is based on the set of beamformed reference signals and is representative of a communications channel between the receive device and the transmit device.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for channel state information feedback based on full channel estimation. The described techniques result in reduced processing, reduced power consumption, more efficient utilization of communication resources. Accordingly, the present techniques provide increased signal quality, throughput, and reliability for communications of device 1005.

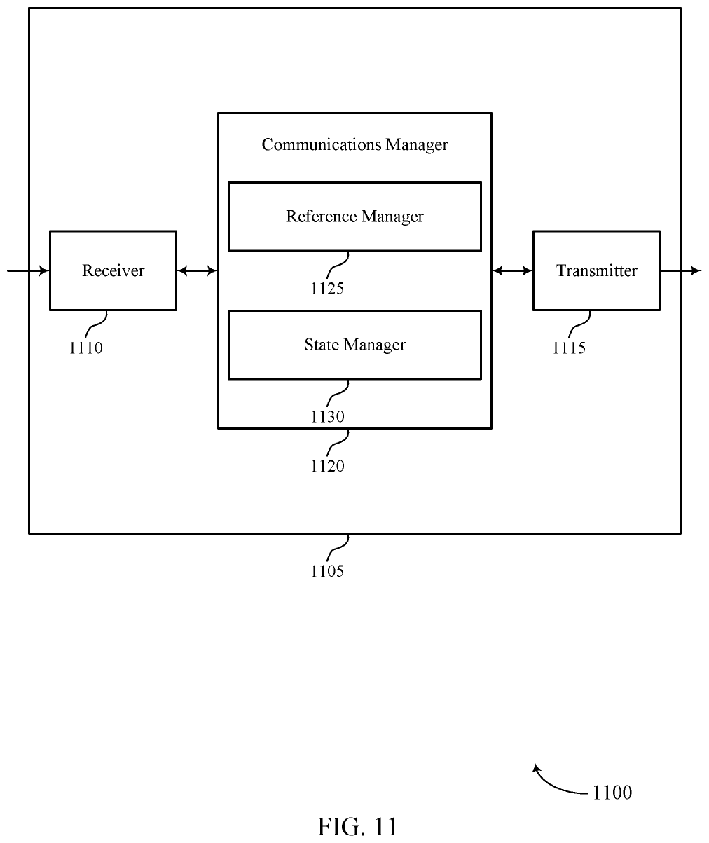

FIG. 11 shows a block diagram 1100 of a device 1105 that supports channel state information feedback based on full channel estimation in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to channel state information feedback based on full channel estimation). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to channel state information feedback based on full channel estimation). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of channel state information feedback based on full channel estimation as described herein. For example, the communications manager 1120 may include a reference manager 1125 a state manager 1130, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a transmit device in accordance with examples as disclosed herein. The reference manager 1125 may be configured as or otherwise support a means for transmitting a set of beamformed reference signals to a receive device via a set of transmit beams of the transmit device, each beamformed reference signal of the set of beamformed reference signals associated with a corresponding receive beam of a set of receive beams of the receive device. The state manager 1130 may be configured as or otherwise support a means for receiving channel state information from the receive device based on a channel matrix, where the channel matrix is based on the set of beamformed reference signals and is representative of a communications channel between the receive device and the transmit device.

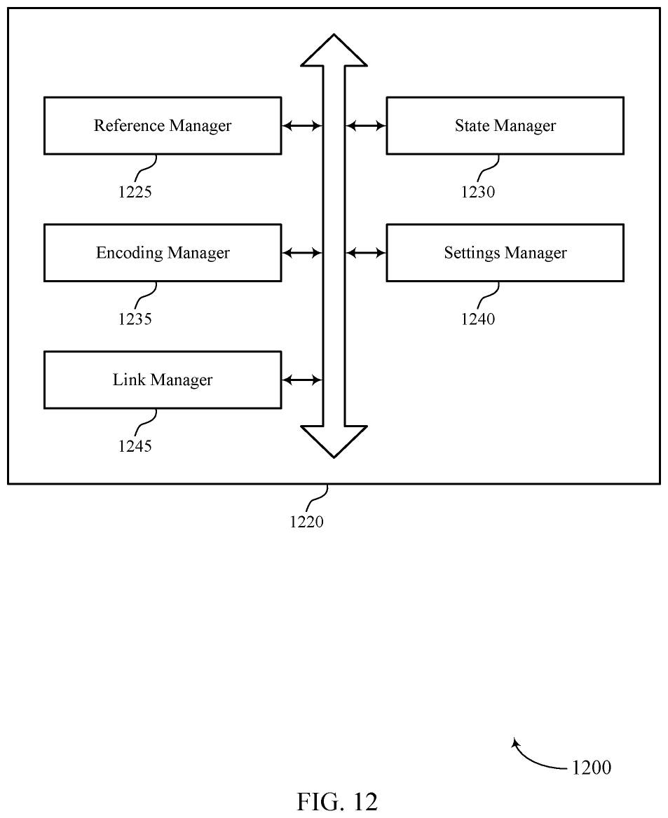

FIG. 12 shows a block diagram 1200 of a communications manager 1220 that supports channel state information feedback based on full channel estimation in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of channel state information feedback based on full channel estimation as described herein. For example, the communications manager 1220 may include a reference manager 1225, a state manager 1230, an encoding manager 1235, a settings manager 1240, a link manager 1245, or any combination thereof. Each of these components may communicate, directly or indirectly, with one another (e.g., via one or more buses).

The communications manager 1220 may support wireless communication at a transmit device in accordance with examples as disclosed herein. The reference manager 1225 may be configured as or otherwise support a means for transmitting a set of beamformed reference signals to a receive device via a set of transmit beams of the transmit device, each beamformed reference signal of the set of beamformed reference signals associated with a corresponding receive beam of a set of receive beams of the receive device. The state manager 1230 may be configured as or otherwise support a means for receiving channel state information from the receive device based on a channel matrix, where the channel matrix is based on the set of beamformed reference signals and is representative of a communications channel between the receive device and the transmit device.

In some examples, to support receiving the channel state information, the encoding manager 1235 may be configured as or otherwise support a means for receiving a compressed representation of the channel matrix. In some examples, to support receiving the channel state information, the encoding manager 1235 may be configured as or otherwise support a means for decompressing the compressed representation of the channel matrix.

In some examples, decompressing the compressed representation of the channel matrix is based on machine learning or a neural network, or both.

In some examples, to support receiving the channel state information, the state manager 1230 may be configured as or otherwise support a means for receiving a precoding matrix indicator that is applicable to or representative of the set of receive beams, a rank indicator that is applicable to or representative of the set of receive beams, or a channel quality indicator that is applicable to or representative of the set of receive beams, or any combination thereof. In some cases, the precoding matrix indicator may be independent of the set of receive beams, the rank indicator may be independent of the set of receive beams, or the channel quality indicator may be independent of the set of receive beams, or any combination thereof.

In some examples, the channel matrix and the channel state information may be specific to a first subband. The reference manager 1225 may be configured as or otherwise support a means for transmitting a second set of beamformed reference signals to the receive device via the set of receive beams, the second set of beamformed reference signals within a second subband. The state manager 1230 may be configured as or otherwise support a means for receiving, from the receive device, second channel state information that is specific to the second subband and is based on a second channel matrix specific to the second subband, where the second channel matrix is based on the second set of beamformed reference signals and is representative of a second communications channel between the receive device and the transmit device within the second subband.

In some examples, a size of at least one dimension of the channel matrix is based on a total quantity of receive antenna ports of the receive device, or a total quantity of transmit antenna ports of the transmit device, or both. In some examples, a size of a first dimension of the channel matrix is equal to the total quantity of receive antenna ports of the receive device. In some examples, a size of a second dimension of the channel matrix is equal to the total quantity of transmit antenna ports of the transmit device. In some examples, the channel state information is independent of each receive beam of the set of receive beams and each transmit beam of the set of transmit beams.

In some examples, the settings manager 1240 may be configured as or otherwise support a means for receiving, from the receive device, a capability message indicating that the receive device is capable of determining the channel matrix representative of the communications channel.

In some examples, the settings manager 1240 may be configured as or otherwise support a means for configuring the receive device to provide the channel state information based on the channel matrix based on a power level of the receive device, a signal quality associated with the receive device, or a power level of a signal associated with the receive device, or any combination thereof.

In some examples, the settings manager 1240 may be configured as or otherwise support a means for transmitting, to the receive device, configuration information indicating resources for receiving the set of beamformed reference signals to determine the channel matrix, resources for transmitting the channel state information based on the channel matrix, or one or more contents of the channel state information based on the channel matrix, or any combination thereof.

In some examples, the link manager 1245 may be configured as or otherwise support a means for communicating with the receive device, after receiving the channel state information, using a transmit beam that is independent of a codebook associated with the set of transmit beams and generated based on the channel matrix.

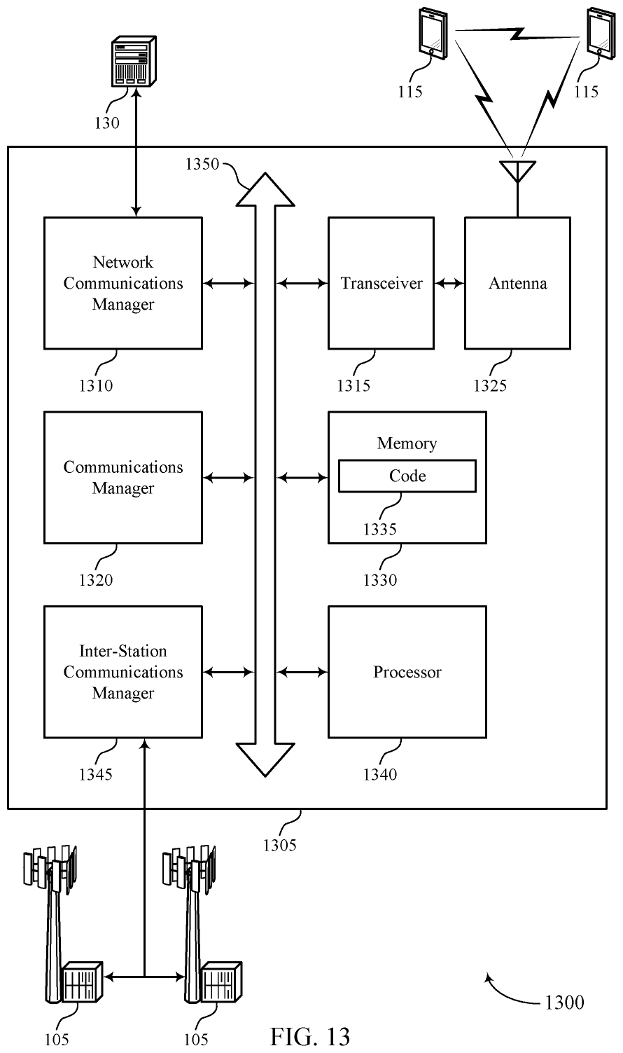

FIG. 13 shows a diagram of a system 1300 including a device 1305 that supports channel state information feedback based on full channel estimation in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting channel state information feedback based on full channel estimation). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communication at a transmit device in accordance with examples as disclosed herein. For example, the communications manager 1320 may be configured as or otherwise support a means for transmitting a set of beamformed reference signals to a receive device via a set of transmit beams of the transmit device, each beamformed reference signal of the set of beamformed reference signals associated with a corresponding receive beam of a set of receive beams of the receive device. The communications manager 1320 may be configured as or otherwise support a means for receiving channel state information from the receive device based on a channel matrix, where the channel matrix is based on the set of beamformed reference signals and is representative of a communications channel between the receive device and the transmit device.

By including or configuring the communications manager 1320 in accordance with examples as described herein, the device 1305 may support techniques for channel state information feedback based on full channel estimation. The described techniques result in improved communication reliability, reduced latency, improved user experience related to reduced processing, reduced power consumption, more efficient utilization of communication resources, improved coordination between devices, longer battery life, improved utilization of processing capability. Accordingly, the present techniques provide increased signal quality, throughput, and reliability for communications of device 1305.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of channel state information feedback based on full channel estimation as described herein, or the processor 1340 and the memory 1330 may be otherwise configured to perform or support such operations.

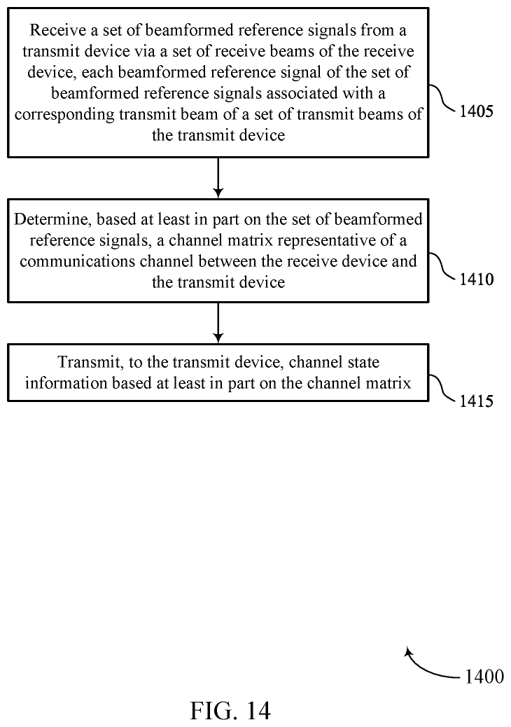

FIG. 14 shows a flowchart illustrating a method 1400 that supports channel state information feedback based on full channel estimation in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving a set of beamformed reference signals from a transmit device via a set of receive beams of the receive device, each beamformed reference signal of the set of beamformed reference signals associated with a corresponding transmit beam of a set of transmit beams of the transmit device. The operations of 1405 may be performed in accordance with examples as disclosed herein. In some examples, aspects of the operations of 1405 may be performed by a beam manager 825 as described with reference to FIG. 8.

At 1410, the method may include determining, based on the set of beamformed reference signals, a channel matrix representative of a communications channel between the receive device and the transmit device. The operations of 1410 may be performed in accordance with examples as disclosed herein. In some examples, aspects of the operations of 1410 may be performed by a channel manager 830 as described with reference to FIG. 8.

At 1415, the method may include transmitting, to the transmit device, channel state information based on the channel matrix. The operations of 1415 may be performed in accordance with examples as disclosed herein. In some examples, aspects of the operations of 1415 may be performed by a feedback manager 835 as described with reference to FIG. 8.

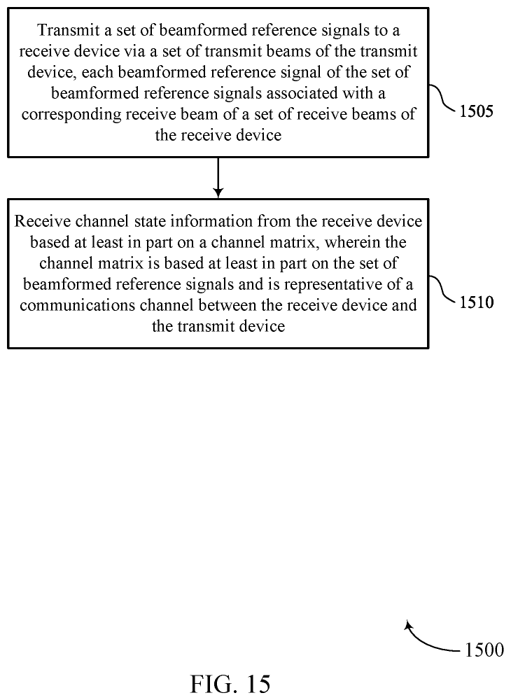

FIG. 15 shows a flowchart illustrating a method 1500 that supports channel state information feedback based on full channel estimation in accordance with aspects of the present disclosure. The operations of the method 1500 may be implemented by a base station or its components as described herein. For example, the operations of the method 1500 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1505, the method may include transmitting a set of beamformed reference signals to a receive device via a set of transmit beams of the transmit device, each beamformed reference signal of the set of beamformed reference signals associated with a corresponding receive beam of a set of receive beams of the receive device. The operations of 1505 may be performed in accordance with examples as disclosed herein. In some examples, aspects of the operations of 1505 may be performed by a reference manager 1225 as described with reference to FIG. 12.

At 1510, the method may include receiving channel state information from the receive device based on a channel matrix, where the channel matrix is based on the set of beamformed reference signals and is representative of a communications channel between the receive device and the transmit device. The operations of 1510 may be performed in accordance with examples as disclosed herein. In some examples, aspects of the operations of 1510 may be performed by a state manager 1230 as described with reference to FIG. 12.

The following provides an overview of aspects of the present disclosure:

Aspect 1: A method for wireless communication at a receive device, comprising: receiving a set of beamformed reference signals from a transmit device via a set of receive beams of the receive device, each beamformed reference signal of the set of beamformed reference signals associated with a corresponding transmit beam of a set of transmit beams of the transmit device; determining, based at least in part on the set of beamformed reference signals, a channel matrix representative of a communications channel between the receive device and the transmit device; and transmitting, to the transmit device, channel state information based at least in part on the channel matrix.

Aspect 2: The method of aspect 1, wherein transmitting the channel state information comprises: transmitting a compressed representation of the channel matrix.

Aspect 3: The method of aspect 2, further comprising: using machine learning or a neural network, or both, to obtain the compressed representation of the channel matrix.

Aspect 4: The method of any of aspects 1 through 3, wherein transmitting the channel state information comprises: transmitting a precoding matrix indicator that is independent of the set of receive beams, a rank indicator that is independent of the set of receive beams, or a channel quality indicator that is independent of the set of receive beams, or any combination thereof.

Aspect 5: The method of any of aspects 1 through 4, wherein the channel matrix and the channel state information are specific to a first subband, the method further comprising: receiving a second set of beamformed reference signals from the transmit device via the set of receive beams, the second set of beamformed reference signals within a second subband; determining, based at least in part on the second set of beamformed reference signals, a second channel matrix that is specific to the second subband and representative of a second communications channel between the receive device and the transmit device within the second subband; and transmitting, to the transmit device, second channel state information based at least in part on the second channel matrix.

Aspect 6: The method of any of aspects 1 through 5, wherein a size of at least one dimension of the channel matrix is based at least in part on a total quantity of receive antenna ports of the receive device, or a total quantity of transmit antenna ports of the transmit device, or both.

Aspect 7: The method of aspect 6, wherein a size of a first dimension of the channel matrix is equal to the total quantity of receive antenna ports of the receive device; and a size of a second dimension of the channel matrix is equal to the total quantity of transmit antenna ports of the transmit device.

Aspect 8: The method of any of aspects 1 through 7, wherein the channel state information is independent of each receive beam of the set of receive beams and each transmit beam of the set of transmit beams.

Aspect 9: The method of any of aspects 1 through 8, further comprising: transmitting, to the transmit device, a capability message indicating that the receive device is capable of determining the channel matrix representative of the communications channel.

Aspect 10: The method of any of aspects 1 through 9, wherein transmitting the channel state information based at least in part on the channel matrix is based at least in part on a power level of the receive device, a signal quality associated with the receive device, or a power level of a signal associated with the receive device, or any combination thereof.

Aspect 11: The method of any of aspects 1 through 10, further comprising: receiving, from the transmit device, configuration information indicating resources for receiving the set of beamformed reference signals to determine the channel matrix, resources for transmitting the channel state information based at least in part on the channel matrix, or one or more contents of the channel state information based at least in part on the channel matrix, or any combination thereof.

Aspect 12: The method of any of aspects 1 through 11, wherein the set of receive beams correspond to a codebook, further comprising: communicating with the transmit device, after transmitting the channel state information, using a receive beam that is independent of a codebook associated with the set of receive beams and generated based at least in part on the channel matrix.

Aspect 13: A method for wireless communication at a transmit device, comprising: transmitting a set of beamformed reference signals to a receive device via a set of transmit beams of the transmit device, each beamformed reference signal of the set of beamformed reference signals associated with a corresponding receive beam of a set of receive beams of the receive device; and receiving channel state information from the receive device based at least in part on a channel matrix, wherein the channel matrix is based at least in part on the set of beamformed reference signals and is representative of a communications channel between the receive device and the transmit device.

Aspect 14: The method of aspect 13, wherein receiving the channel state information comprises: receiving a compressed representation of the channel matrix; and decompressing the compressed representation of the channel matrix.

Aspect 15: The method of aspect 14, wherein decompressing the compressed representation of the channel matrix is based at least in part on machine learning or a neural network, or both.

Aspect 16: The method of any of aspects 13 through 15, wherein receiving the channel state information comprises: receiving a precoding matrix indicator that is independent of the set of receive beams, a rank indicator that is independent of the set of receive beams, or a channel quality indicator that is independent of the set of receive beams, or any combination thereof.

Aspect 17: The method of any of aspects 13 through 16, wherein the channel matrix and the channel state information are specific to a first subband, the method further comprising: transmitting a second set of beamformed reference signals to the receive device via the set of receive beams, the second set of beamformed reference signals within a second subband; receiving, from the receive device, second channel state information that is specific to the second subband and is based at least in part on a second channel matrix specific to the second subband, wherein the second channel matrix is based at least in part on the second set of beamformed reference signals and is representative of a second communications channel between the receive device and the transmit device within the second subband.

Aspect 18: The method of any of aspects 13 through 17, wherein a size of at least one dimension of the channel matrix is based at least in part on a total quantity of receive antenna ports of the receive device, or a total quantity of transmit antenna ports of the transmit device, or both.

Aspect 19: The method of aspect 18, wherein a size of a first dimension of the channel matrix is equal to the total quantity of receive antenna ports of the receive device; and a size of a second dimension of the channel matrix is equal to the total quantity of transmit antenna ports of the transmit device.

Aspect 20: The method of any of aspects 13 through 19, wherein the channel state information is independent of each receive beam of the set of receive beams and each transmit beam of the set of transmit beams.

Aspect 21: The method of any of aspects 13 through 20, further comprising: receiving, from the receive device, a capability message indicating that the receive device is capable of determining the channel matrix representative of the communications channel.

Aspect 22: The method of any of aspects 13 through 21, further comprising: configuring the receive device to provide the channel state information based at least in part on the channel matrix based at least in part on a power level of the receive device, a signal quality associated with the receive device, or a power level of a signal associated with the receive device, or any combination thereof.

Aspect 23: The method of any of aspects 13 through 22, further comprising: transmitting, to the receive device, configuration information indicating resources for receiving the set of beamformed reference signals to determine the channel matrix, resources for transmitting the channel state information based at least in part on the channel matrix, or one or more contents of the channel state information based at least in part on the channel matrix, or any combination thereof.

Aspect 24: The method of any of aspects 13 through 23, wherein the set of receive beams correspond to a codebook, further comprising: communicating with the receive device, after receiving the channel state information, using a transmit beam that is independent of a codebook associated with the set of transmit beams and generated based at least in part on the channel matrix.

Aspect 25: An apparatus for wireless communication at a receive device, comprising a processor; memory coupled with the processor; and instructions stored in the memory and executable by the processor to cause the apparatus to perform a method of any of aspects 1 through 12.

Aspect 26: An apparatus for wireless communication at a receive device, comprising at least one means for performing a method of any of aspects 1 through 12.

Aspect 27: A non-transitory computer-readable medium storing code for wireless communication at a receive device, the code comprising instructions executable by a processor to perform a method of any of aspects 1 through 12.

Aspect 28: An apparatus for wireless communication at a transmit device, comprising a processor; memory coupled with the processor; and instructions stored in the memory and executable by the processor to cause the apparatus to perform a method of any of aspects 13 through 24.

Aspect 29: An apparatus for wireless communication at a transmit device, comprising at least one means for performing a method of any of aspects 13 through 24.

Aspect 30: A non-transitory computer-readable medium storing code for wireless communication at a transmit device, the code comprising instructions executable by a processor to perform a method of any of aspects 13 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a receive device, comprising:
a processor;
memory coupled with the processor; and
instructions stored in the memory and executable by the processor to cause the apparatus to:
receive a set of beamformed reference signals from a transmit device via a set of receive beams of the receive device, each beamformed reference signal of the set of beamformed reference signals associated with a corresponding transmit beam of a set of transmit beams of the transmit device;
determine, based at least in part on the set of beamformed reference signals, a channel matrix representative of a communications channel between the receive device and the transmit device; and
transmit, to the transmit device, channel state information based at least in part on the channel matrix.

2. The apparatus of claim 1, wherein, to transmit the channel state information, the instructions are executable by the processor to cause the apparatus to:
transmit a compressed representation of the channel matrix.

3. The apparatus of claim 2, wherein the instructions are further executable by the processor to cause the apparatus to:
use machine learning or a neural network, or both, to obtain the compressed representation of the channel matrix.

4. The apparatus of claim 1, wherein, to transmit the channel state information, the instructions are executable by the processor to cause the apparatus to:
transmit a precoding matrix indicator that is independent of the set of receive beams, a rank indicator that is independent of the set of receive beams, or a channel quality indicator that is independent of the set of receive beams, or any combination thereof.

5. The apparatus of claim 1, wherein the channel matrix and the channel state information are specific to a first subband, and wherein the instructions are further executable by the processor to cause the apparatus to:
receive a second set of beamformed reference signals from the transmit device via the set of receive beams, the second set of beamformed reference signals within a second subband;
determine, based at least in part on the second set of beamformed reference signals, a second channel matrix that is specific to the second subband and representative of a second communications channel between the receive device and the transmit device within the second subband; and
transmit, to the transmit device, second channel state information based at least in part on the second channel matrix.

6. The apparatus of claim 1, wherein a size of at least one dimension of the channel matrix is based at least in part on a total quantity of receive antenna ports of the receive device, or a total quantity of transmit antenna ports of the transmit device, or both.

7. The apparatus of claim 6, wherein:
a size of a first dimension of the channel matrix is equal to the total quantity of receive antenna ports of the receive device; and
a size of a second dimension of the channel matrix is equal to the total quantity of transmit antenna ports of the transmit device.

8. The apparatus of claim 1, wherein the channel state information is independent of each receive beam of the set of receive beams and each transmit beam of the set of transmit beams.

9. The apparatus of claim 1, wherein the instructions are further executable by the processor to cause the apparatus to:
transmit, to the transmit device, a capability message indicating that the receive device is capable of determining the channel matrix representative of the communications channel.

10. The apparatus of claim 1, wherein transmitting the channel state information based at least in part on the channel matrix is based at least in part on a power level of the receive device, a signal quality associated with the receive device, or a power level of a signal associated with the receive device, or any combination thereof.

11. The apparatus of claim 1, wherein the instructions are further executable by the processor to cause the apparatus to:
receive, from the transmit device, configuration information indicating resources for receiving the set of beamformed reference signals to determine the channel matrix, resources for transmitting the channel state information based at least in part on the channel matrix, or one or more contents of the channel state information based at least in part on the channel matrix, or any combination thereof.

12. The apparatus of claim 1, wherein the instructions are further executable by the processor to cause the apparatus to:
communicate with the transmit device, after transmitting the channel state information, using a receive beam that is independent of a codebook associated with the set of receive beams and generated based at least in part on the channel matrix.

13. An apparatus for wireless communication at a transmit device, comprising:
a processor;
memory coupled with the processor; and
instructions stored in the memory and executable by the processor to cause the apparatus to:
transmit a set of beamformed reference signals to a receive device via a set of transmit beams of the transmit device, each beamformed reference signal of the set of beamformed reference signals associated with a corresponding receive beam of a set of receive beams of the receive device; and
receive channel state information from the receive device based at least in part on a channel matrix, wherein the channel matrix is based at least in part on the set of beamformed reference signals and is representative of a communications channel between the receive device and the transmit device.

14. The apparatus of claim 13, wherein, to receive the channel state information, the instructions are executable by the processor to cause the apparatus to:
receive a compressed representation of the channel matrix; and
decompress the compressed representation of the channel matrix.

15. The apparatus of claim 14, wherein decompressing the compressed representation of the channel matrix is based at least in part on machine learning or a neural network, or both.

16. The apparatus of claim 13, wherein, to receive the channel state information, the instructions are executable by the processor to cause the apparatus to:
receive a precoding matrix indicator that is independent of the set of receive beams, a rank indicator that is independent of the set of receive beams, or a channel quality indicator that is independent of the set of receive beams, or any combination thereof.

17. The apparatus of claim 13, wherein the channel matrix and the channel state information are specific to a first subband, and wherein the instructions are further executable by the processor to cause the apparatus to:
transmit a second set of beamformed reference signals to the receive device via the set of receive beams, the second set of beamformed reference signals within a second subband;
receive, from the receive device, second channel state information that is specific to the second subband and is based at least in part on a second channel matrix specific to the second subband, wherein the second channel matrix is based at least in part on the second set of beamformed reference signals and is representative of a second communications channel between the receive device and the transmit device within the second subband.

18. The apparatus of claim 13, wherein a size of at least one dimension of the channel matrix is based at least in part on a total quantity of receive antenna ports of the receive device, or a total quantity of transmit antenna ports of the transmit device, or both.

19. The apparatus of claim 18, wherein:
a size of a first dimension of the channel matrix is equal to the total quantity of receive antenna ports of the receive device; and
a size of a second dimension of the channel matrix is equal to the total quantity of transmit antenna ports of the transmit device.

20. The apparatus of claim 13, wherein the channel state information is independent of each receive beam of the set of receive beams and each transmit beam of the set of transmit beams.

21. The apparatus of claim 13, wherein the instructions are further executable by the processor to cause the apparatus to:
receive, from the receive device, a capability message indicating that the receive device is capable of determining the channel matrix representative of the communications channel.

22. The apparatus of claim 13, wherein the instructions are further executable by the processor to cause the apparatus to:
configure the receive device to provide the channel state information based at least in part on the channel matrix based at least in part on a power level of the receive device, a signal quality associated with the receive device, or a power level of a signal associated with the receive device, or any combination thereof.

23. The apparatus of claim 13, wherein the instructions are further executable by the processor to cause the apparatus to:
transmit, to the receive device, configuration information indicating resources for receiving the set of beamformed reference signals to determine the channel matrix, resources for transmitting the channel state information based at least in part on the channel matrix, or one or more contents of the channel state information based at least in part on the channel matrix, or any combination thereof.

24. The apparatus of claim 13, wherein the instructions are further executable by the processor to cause the apparatus to:
communicate with the receive device, after receiving the channel state information, using a transmit beam that is independent of a codebook associated with the set of transmit beams and generated based at least in part on the channel matrix.

25. A method for wireless communication at a receive device, comprising:
receiving a set of beamformed reference signals from a transmit device via a set of receive beams of the receive device, each beamformed reference signal of the set of beamformed reference signals associated with a corresponding transmit beam of a set of transmit beams of the transmit device;
determining, based at least in part on the set of beamformed reference signals, a channel matrix representative of a communications channel between the receive device and the transmit device; and
transmitting, to the transmit device, channel state information based at least in part on the channel matrix.

26. The method of claim 25, wherein transmitting the channel state information comprises:
transmitting a compressed representation of the channel matrix.

27. The method of claim 26, further comprising:
using machine learning or a neural network, or both, to obtain the compressed representation of the channel matrix.

28. The method of claim 25, wherein transmitting the channel state information comprises:
transmitting a precoding matrix indicator that is independent of the set of receive beams, a rank indicator that is independent of the set of receive beams, or a channel quality indicator that is independent of the set of receive beams, or any combination thereof.

29. A method for wireless communication at a transmit device, comprising:
transmitting a set of beamformed reference signals to a receive device via a set of transmit beams of the transmit device, each beamformed reference signal of the set of beamformed reference signals associated with a corresponding receive beam of a set of receive beams of the receive device; and
receiving channel state information from the receive device based at least in part on a channel matrix, wherein the channel matrix is based at least in part on the set of beamformed reference signals and is representative of a communications channel between the receive device and the transmit device.

30. The method of claim 29, wherein receiving the channel state information comprises:
receiving a compressed representation of the channel matrix; and
decompressing the compressed representation of the channel matrix.
